(19) United States
(12) Patent Application Publication
(10) Pub. No.: US 2006/0293133 A1
(43) Pub. Date: Dec. 28, 2006

(54) Dual pivoting pawl tensioner

(75) Inventor: Roger T. Simpson, Ithaca, NY (US)

Correspondence Address: BORGWARNER INC., 3850 HAMLIN ROAD, AUBURN HILLS, MI, 48326, US

(73) Assignee: BorgWarner Inc., Auburn Hills, MI (US)

(21) Appl. No.: 11/169,056

(22) Filed: Jun. 28, 2005

(51) Int. Cl. F16H 7/08; F16H 7/22

(52) U.S. Cl. 474/109; 474/110

(57) ABSTRACT

A tensioner including a housing, a piston, a piston spring, a first pawl and a second pawl. The housing has a bore for slidably receiving a piston. The piston has a plurality of teeth formed along at least a portion of the outer circumference of the piston. The piston spring biases the piston in an outward direction from the bore. The first and second pawls are pivotally attached by a pin and received by grooves in the housing. The pawls are biased toward the teeth of the piston by first and second springs. The pawls are preferably adjacent to each other or 180 degrees apart. The first pawl is preferably half a pitch ahead of the second pawl, such that when the second pawl ratchets a tooth on the piston, the first pawl is sliding along the ramp toward the next tooth.

### BACKGROUND OF THE INVENTION

1. Field Of The Invention

The invention pertains to the field of tensioners. More particularly, the invention pertains to dual pivoting pawl tensioners.

2. Description Of Related Art

Chain tensioners in engines are used to control the power transmission chains as the chain travels around a plurality of sprockets. The slack of the chain varies as the temperature in an engine increases and as the chain wears. When a chain wears, the chain elongates and the slack in the chain increases. The increase in slack may cause noise, slippage, or tooth jumping between the chain and the sprocket teeth. If the increase of slack in the chain is not taken up by a tensioner for example, in an engine with a chain driven camshaft, the engine may be damaged because the camshaft timing is misaligned by several degrees due to slippage or tooth jumping.

A tensioning device, such as a hydraulic tensioner, is used as a control device for a power transmission chain, or similar power transmission devices, as the chain travels between a plurality of sprockets. In this device, the chain transmits power from a driving shaft to a driven shaft, so that part of the chain is slack and part of the chain is tight. Generally, it is important to impart and maintain a certain degree of tension in the chain to prevent noise, slippage, or the unmeshing of teeth in the case of a toothed chain. Prevention of such slippage is particularly important in the case of a chain driven camshaft in an internal combustion engine because jumping of teeth will throw off the camshaft timing, possibly causing damage or rendering the engine inoperative. The hydraulic tensioner usually employs a lever arm that pushes against the chain on the slack side of the power transmission system. This lever arm must push toward the chain, tightening the chain when the chain is slack, and must be very rigid when the chain tightens.

However, in the harsh environment of an internal combustion engine, various factors can cause fluctuations in the chain tension. For instance, wide variations in temperature and thermal expansion coefficients among the various parts of the engine can cause the chain slack to vary between excessively high or low levels. During prolonged use, wear to the components of the power transmission system can cause an increase in chain slack. In addition, camshaft and crankshaft induced torsional vibrations cause considerable variations in chain tensions. Reverse rotation of an engine, occurring for example in stopping or in failed attempts at starting, can also cause fluctuations in chain tension. For these reasons, a mechanism is desired to remove excessive tensioning forces on the tight side of the chain and to ensure the necessary tension on the slack side of the chain.

To accomplish this result, a hydraulic tensioner 1, as shown in prior art FIG. 1, typically comprises a rod or cylinder as a piston 2, which is biased in the direction of the chain by a tensioner spring 3. The piston 2 is housed within a cylindrical housing 5, having an interior space which is open at the end facing the chain and closed at the other end. The interior space of the housing contains a pressure chamber 4 in connection with a reservoir or exterior source of hydraulic fluid pressure. The pressure chamber 4 is typically formed between the housing 5 and the piston 2, and it expands or contracts when the piston 2 moves within the housing 5.

Typically, valves are employed to regulate the flow of fluid into and out of the pressure chamber. For instance, an inlet check valve 6 typically includes a ball-check valve that opens to permit fluid flow in to the pressure chamber 4 when the pressure inside the chamber has decreased as a result of outward movement of the piston 2. When the pressure in the pressure chamber is high, the inlet check valve closes, preventing fluid from exiting the pressure chamber. The closing of the inlet check valve 6 prevents the piston chamber from contracting, which in turn prevents the piston from retracting, achieving a so-called “no-return” function.

Many tensioners also employ a pressure relief mechanism that allows fluid to exit the pressure chamber when the pressure in the chamber is high, thus allowing the piston to retract in response to rapid increases in chain tension. In some tensioners, the pressure relief mechanism is a spring biased check valve. The check valve opens when the pressure exceeds a certain pressure point. Some tensioners may employ a valve which performs both the inlet check function as well as the pressure relief function.

Other mechanisms employ a restricted path through which fluid may exit the fluid chamber, such that the volume of flow exiting the fluid chamber is minimal unless the pressure in the fluid chamber is great. For instance, a restricted path may be provided through the clearance between the piston and bore, through a vent tube in the protruding end of the piston, or through a vent member between the fluid chamber and the fluid reservoir.

Prior art FIG. 2a shows a schematic of a tensioner biasing an arm to tension a chain in U.S. Pat. No. 4,874,352. FIG. 2b shows an exploded view of the tensioner in FIG. 2a. The tensioner 30 has a housing 31 with a bore for receiving a hollow plunger 32. The hollow plunger 32 has an opened end and closed end 32a for biasing an arm 15 and subsequently chain C. The hollow plunger 32 is biased outwards from the housing 31 by spring 34. Along the outer surface of the hollow plunger 32 is a rack 33 of teeth in which a ratchet 40 engages. The ratchet 40 is rotatably supported in the housing 31 and biased by a spring 41 in a direction opposite to the protruding direction. A chamber 36 is formed between the housing 31 and the hollow plunger 32. An inlet check valve S, R, B, 38, 39 permits fluid from passages 37, 39 into the chamber 36 to bias the tensioner in protruding direction from the housing 31.

U.S. Pat. No. 4,822,320 discloses a ratchet-type tensioner with a rack formed on the plunger that meshes with a ratchet. The ratchet is pivotally connected to the housing to permit a positive backlash not less than a predetermined amount.

U.S. Pat. No. 6,240,602 discloses a dual spacing clamp tie for securing wires, cables, hoses, and tubing in a parallel relationship with each other. The dual spacing clamp tie includes a locking head an two straps extending outwardly in opposite directions from the locking head. A pair of releasable pawls secures the straps around the items to be secured. The pawls are wedge shaped, carried at the end of integrally formed hinge that enables the pawl to pivot relative to the locking head, and have a surface with a plurality of teeth for engagement with the serrations formed on the adjacent side of each strap. One of problems with the hinged pawls in U.S. Pat. No. 6,240,602 is that due to the angle and incline the pawls and the engagement with either the strap or the mounting element, the pawls cannot provide any backlash. Furthermore, if either the strap or the mounting element were jerked in a certain direction, the hinges would snap.

JP 60-121355 discloses a plunger of a tensioner that has a rack like portion adjacent to a smooth or slide surface portion along the longitudinal upper surface of the plunger. A first ratchet pawl engages the rack portion on the plunger. When the first ratchet pawl is in between teeth, a second pawl or friction member without teeth, adjacent to the first ratchet pawl, acts as a cotter or wedge as it is brought into contact with the flat portion of the slide surface on the plunger. Backlash is not provided.

### SUMMARY OF THE INVENTION

A tensioner system has a housing, a hollow piston, a piston spring, a first pawl and a second pawl. The housing has a bore for slidably receiving a piston. The piston, which may form a fluid chamber with the bore, has a plurality of teeth formed along the outside of the piston. The plurality of teeth may be present around the entire the outer circumference of the piston or alternatively the plurality of teeth may be inset into only a portion of the piston's outer circumference. The piston spring biases the piston in an outward direction from the bore.

The first and second pawls are pivotally attached by a pin and received by grooves in the housing. The pawls are biased toward the teeth of the piston by first and second springs. In one embodiment, the pawls are adjacent to each other. In another embodiment, the pawls are preferably spaced 180 degrees apart. Alternatively, other spacing between the pawls may also be present. The first pawl is preferably half a pitch ahead of the second pawl, such that when the second pawl ratchets a tooth on the piston, the first pawl is sliding along the ramp toward the next tooth. The second pawl takes up any backlash or backward movement of the piston relative to the housing. Alternatively, the first and second pawls may also hold the same position along the teeth of the piston. The first pawl may be a smaller than half a pitch or larger than half a pitch ahead of the second pawl.

### BRIEF DESCRIPTION OF THE DRAWINGS

FIG. 1 shows a prior art hydraulic tensioner.

FIG. 2a shows a schematic of a prior art tensioner biasing an arm and tensioning a chain.

FIG. 2b shows an exploded view of the prior art tensioner of FIG. 2a.

FIG. 3 shows a side view of the tensioner of the first embodiment.

FIG. 4 shows a section of the tensioner of the first embodiment along line A-A of FIG. 3.

FIG. 5 shows a schematic of the pawls engaging the piston of the tensioner.

FIG. 6a shows a close-up of the left pawl engagement with the piston.

FIG. 6b shows a close-up of the right pawl engagement with the piston.

FIG. 7 shows a schematic of the tensioner of the second embodiment.

FIG. 8 shows a section of the tensioner of the second embodiment along line B-B of FIG. 7.

FIG. 9 shows a side view of the tensioner of the second embodiment.

FIG. 10a shows a section of the tensioner of the second embodiment along line B-B of

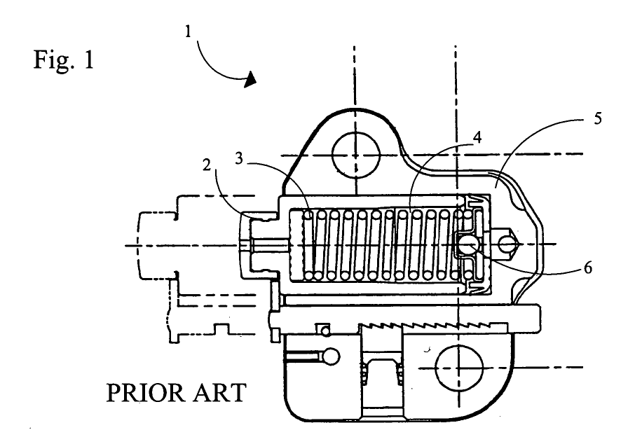

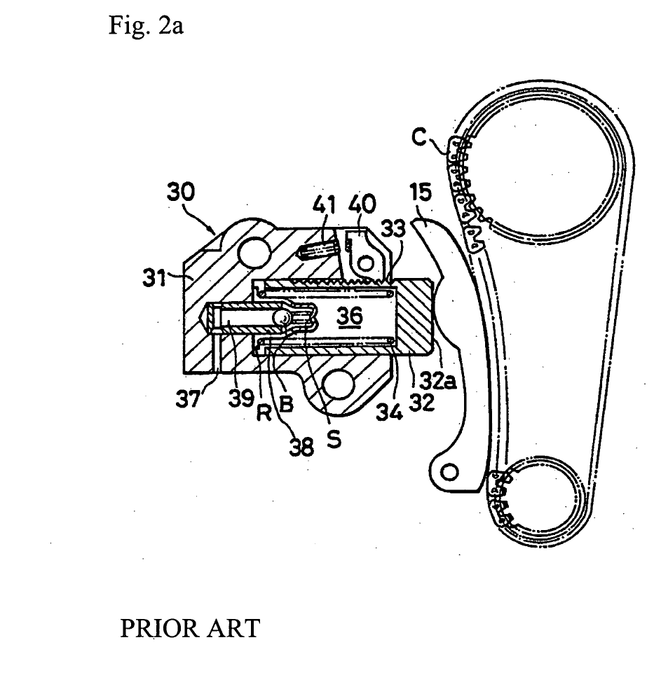

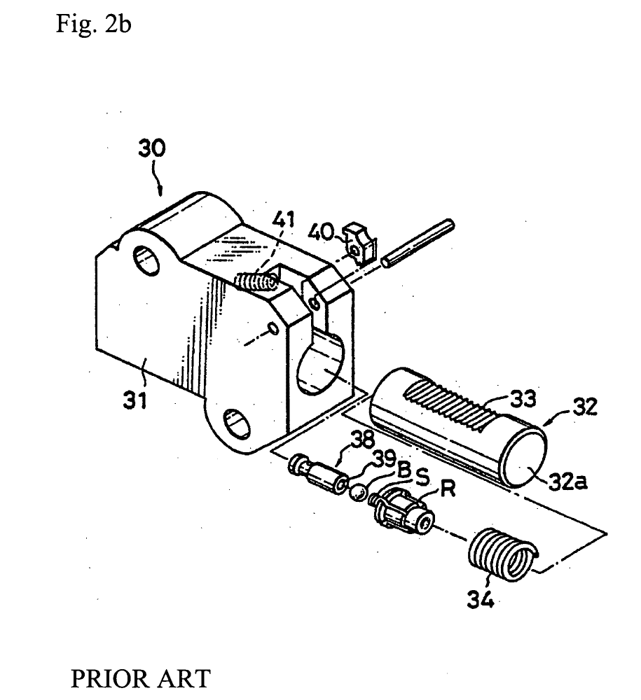

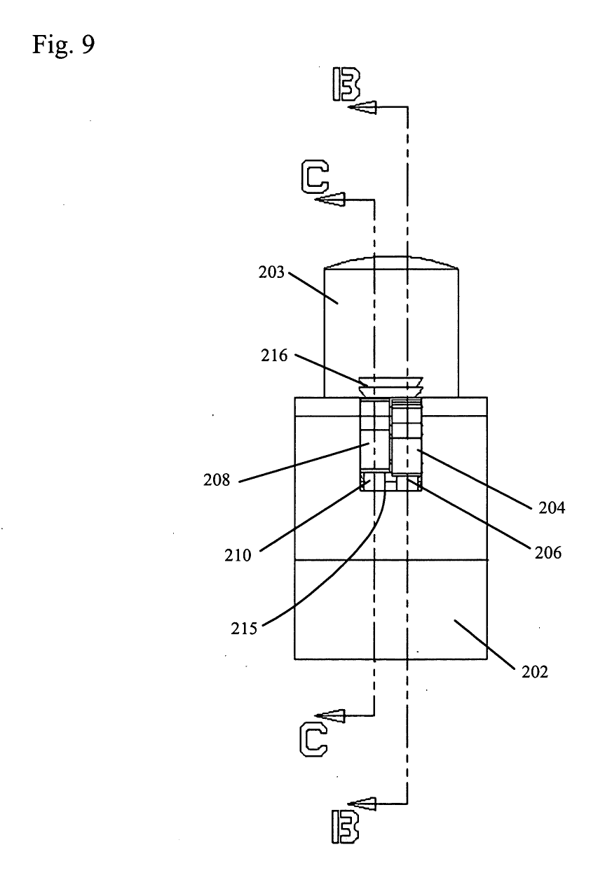

FIG. 9 with a first pawl engaging the piston.

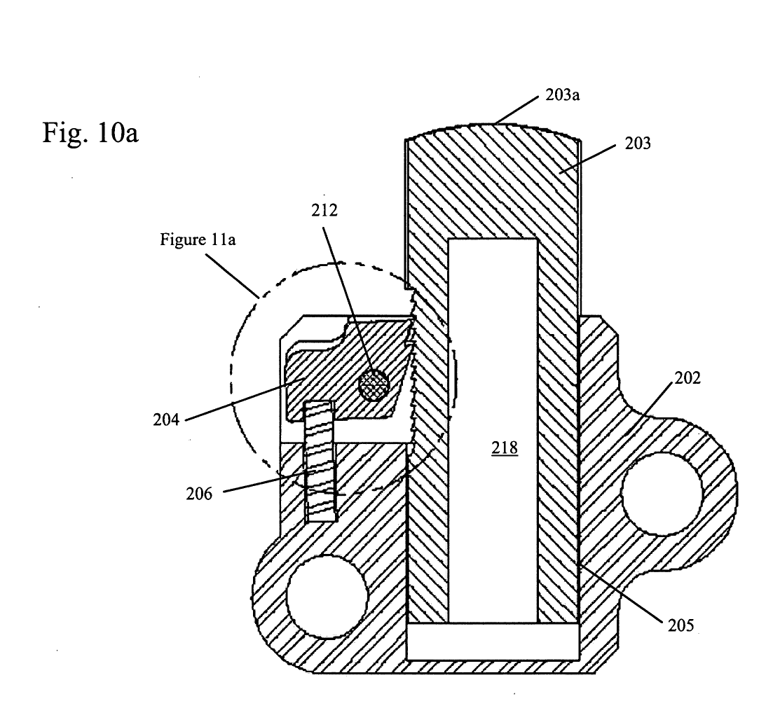

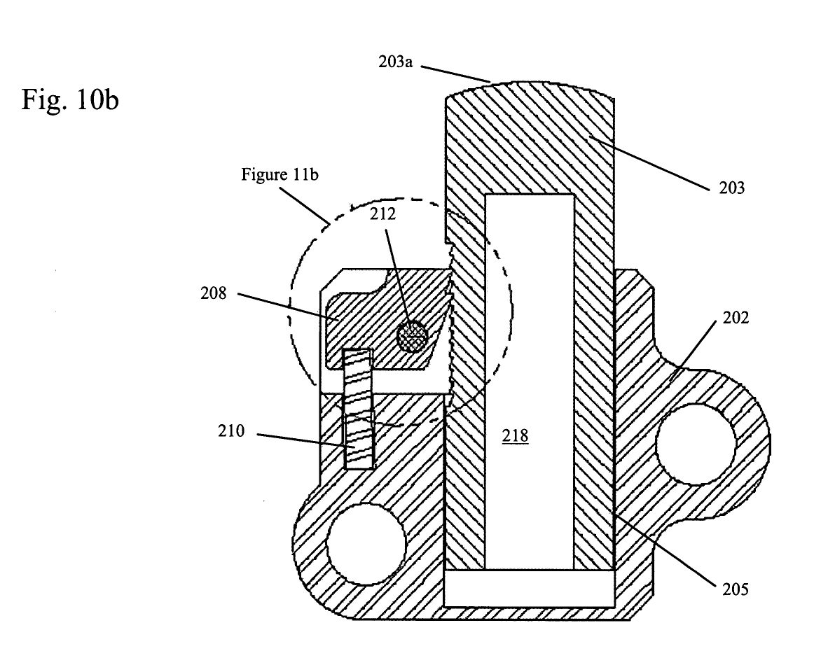

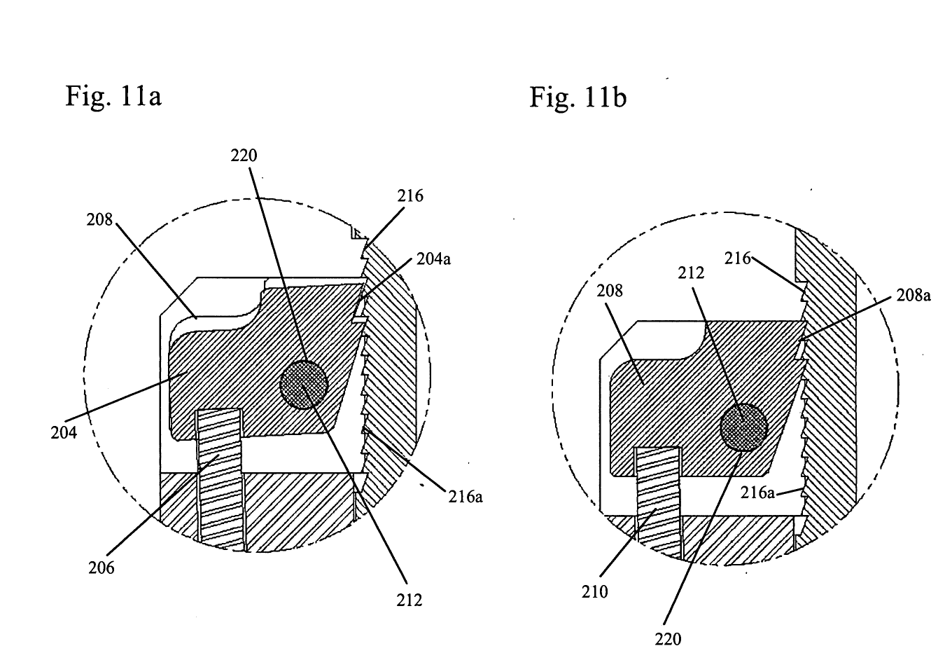

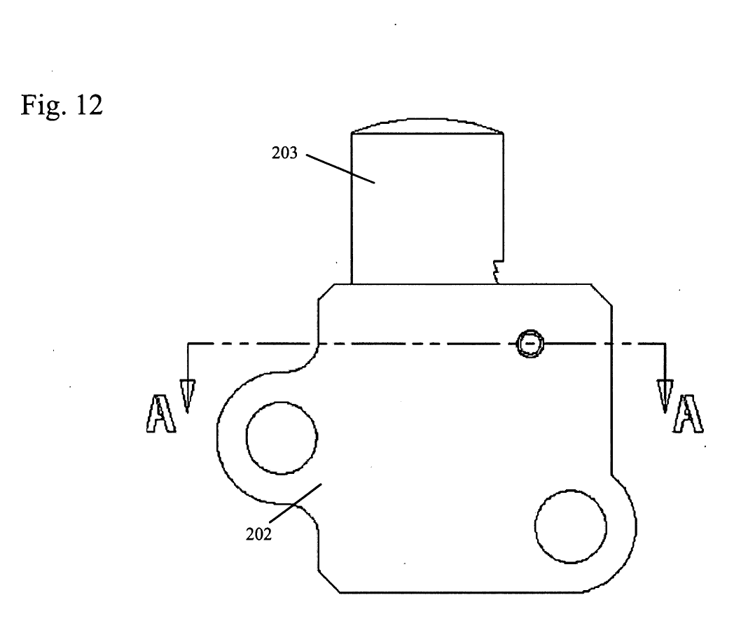

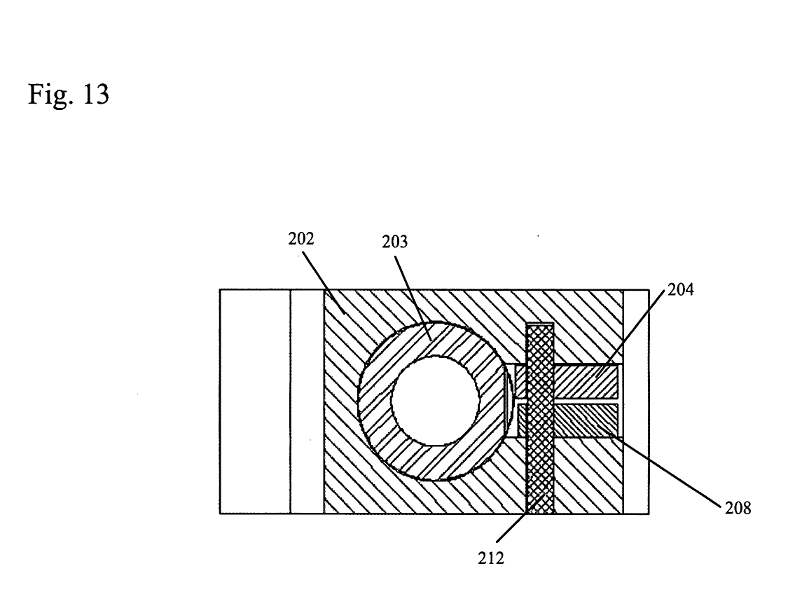

FIG. 10b shows a section of the tensioner of the second embodiment along line C-C of

FIG. 9 with a second pawl engaging the piston.

FIG. 11a shows a close-up of the first pawl engagement with the piston of the second embodiment.

FIG. 11b shows a close-up of the second pawl engagement with the piston of the second embodiment.

FIG. 12 shows a schematic of the tensioner of the second embodiment.

FIG. 13 shows a section of the tensioner of the second embodiment along line A-A of FIG. 12.

### DETAILED DESCRIPTION OF THE INVENTION

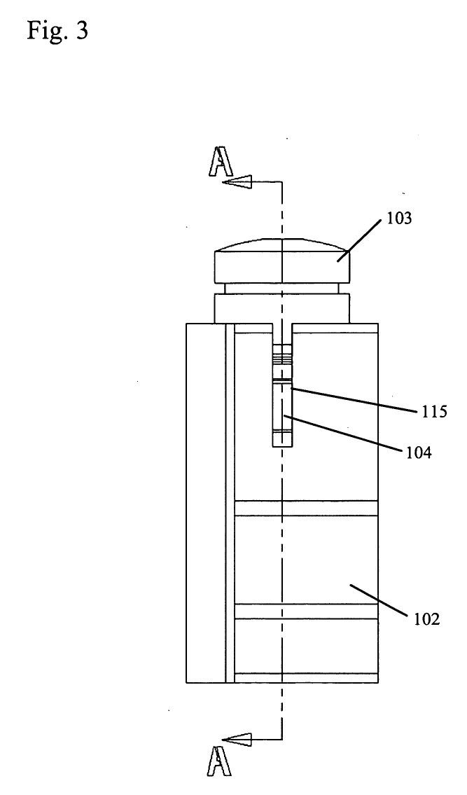

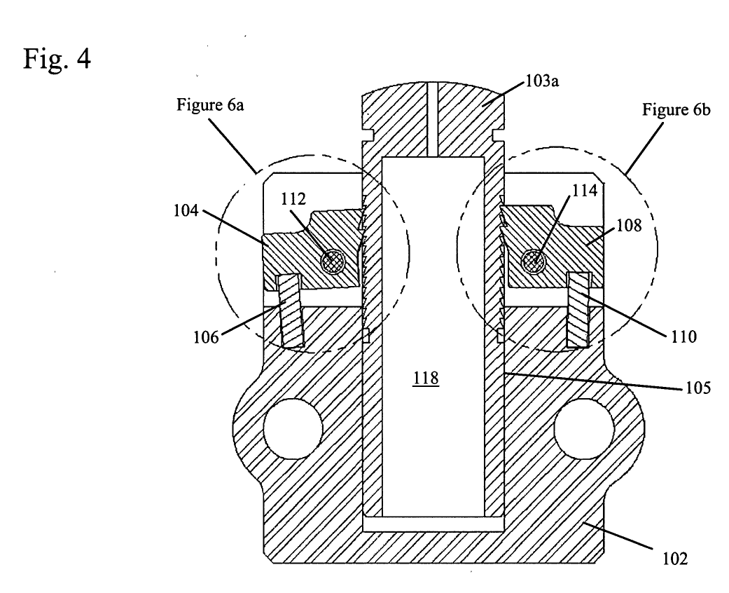

FIGS. 3 and 4 show a tensioner in a first embodiment of the present invention. The tensioner has a housing 102 with a bore 105 for receiving a hollow piston 103. The hollow piston has an opened end and a closed end 103a for biasing an arm or other surface. A chamber 118 is formed between the housing 102 and the interior of the hollow piston 103 and receives hydraulic fluid from a pressurized source through a fluid line and a check valve (not shown). At least a portion of the outer circumference of the hollow piston 103 has grooves or teeth 116 integrally formed for meshing or engagement with pawls 104, 108. A stop groove may also be present on the outer circumference of the piston for preventing axial movement of the piston. The pawls 104, 108 are received by grooves 115 in the housing and are preferably present on either side of the piston 103 or spaced 180 degrees apart. The pawls 104, 108 are biased by springs 106, 110.

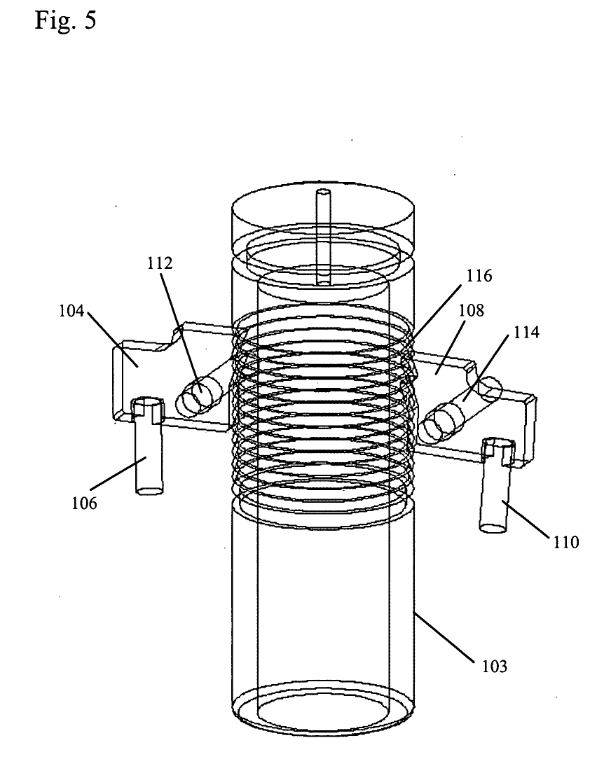

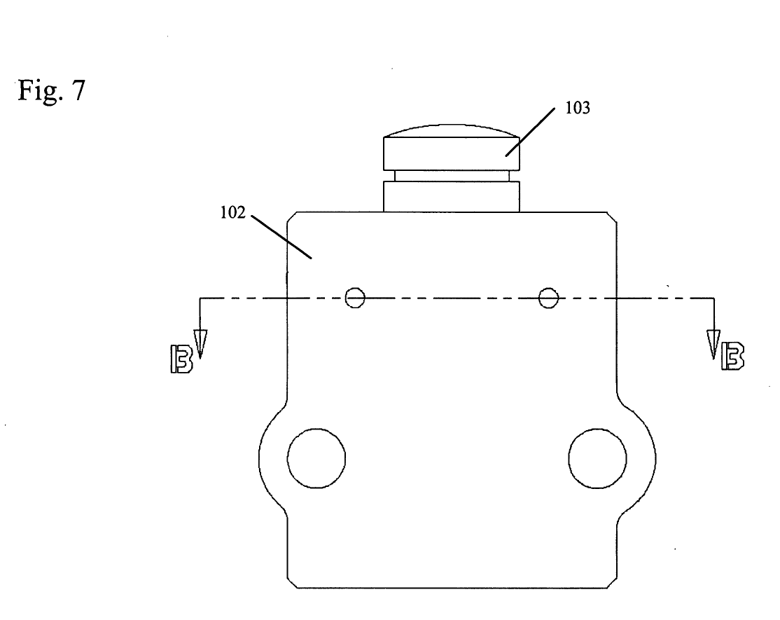

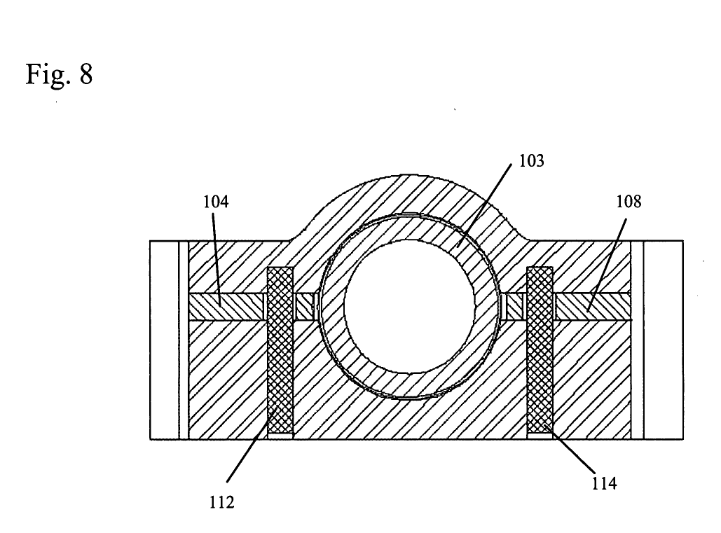

FIGS. 5 through 8 show the position of the pawls 104, 108 relative to the piston 103 of the tensioner. Referring to FIG. 5, the pawls 104, 108 are located opposite each other, on either side of the piston, 180 degrees apart. The springs 106, 110 bias the pawls towards the center of the piston 103 or towards engagement with the teeth on the outer circumference of the piston. A centrally located hole 120 in the pawls 104, 108 and the housing 102 receives an extended pin 112, 114. The pawls 104, 108 pivot about the extended pins 112, 114. The position of the pins 112, 114 relative to the pawls 104, 108 and the piston 103 is shown in FIG. 8.

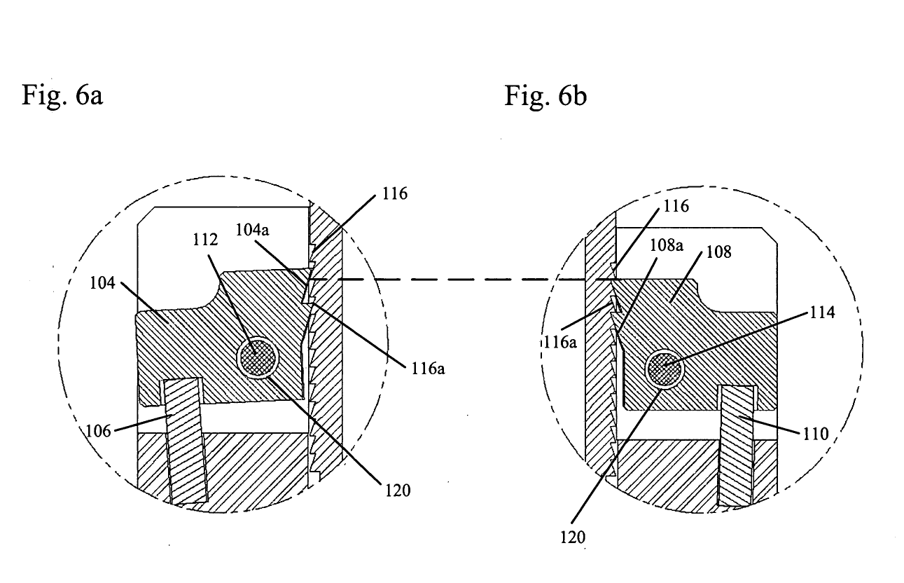

FIG. 6a shows the left pawl 104 or first pawl with teeth 104a in contact with the teeth or grooves 116 on the outer circumference of the piston 103. FIG. 6b shows the right pawl 108 or second pawl with teeth 108a, opposite the first pawl, meshed with the teeth or grooves 116 on the outer circumference of the piston 103. In comparing the positions of the first and second pawls 104, 108, one pawl, in this case the first tooth 104a of the first pawl 104 is half a pitch ahead of the first tooth 108a of the second pawl 108 (see dashed line connecting FIGS. 6a and 6b) as the pawls move down and the piston moves outward. In other words, while the teeth 108a of the second pawl 108 are engaged or ratcheted with the teeth 116 of the piston 103, the first pawl 104 is moving or sliding down along the ramp 116a between the tooth engaged by the second pawl 108 and the next tooth 116 along the piston 103. By offsetting the position of the first pawl 104 relative to the second pawl 108 by half a pitch, finer adjustment of the piston 103 position and the tension it provides is achieved, since the first pawl 104 can adjust the back position and then when the piston moves out half a pitch the second pawl takes up any backlash or backward movement that may occur. In one embodiment, the teeth 116 on the piston 103 are larger than in the prior art, giving the teeth 116 on the piston greater strength and resistance to wear. In another embodiment, the pawls 104, 108 may be thicker than in the prior art, therefore able to handle a greater load and are more resistant to wear.

In another preferred embodiment, the pawls 104, 108 hold the same position along the grooves or teeth 116 of the outer circumference of the piston 103, ensuring that if one of the pawls 104, 108 failed, the position of the piston 103 remains the same since the other pawl 104, 108 is also engaging the teeth 116 of the piston 103.

Alternatively, the pitch between the first tooth 104a of the first pawl 104 and the first tooth 108a of the second pawl 108 may be less than a half pitch or greater than a half pitch.

FIGS. 9, 10a, and 10b show a tensioner in the second embodiment of the present invention. The tensioner has a housing 202 with a bore 205 for receiving a hollow piston 203. The hollow piston has an opened end and a closed end 203a for biasing an arm or other surface. A chamber 218 is formed between the housing 202 and the interior of the hollow piston 203 and receives hydraulic fluid from a pressurized source through a fluid line and a check valve (not shown). At least a portion of the outer circumference of the hollow piston 203 has grooves or teeth 216 integrally formed for meshing or engagement with pawls 204, 208. A stop groove may also be present on the outer circumference of the piston for preventing axial movement of the piston. The pawls are received by a groove 215 in the housing 202 and are present adjacent to or next to each other as shown in FIGS. 9 and 13. The pawls 204, 208 are biased by springs 206, 210.

FIGS. 10a through 13 show the position of the pawls 204, 208 relative to the piston 203 of the tensioner and each other. Referring again to FIGS. 9 and 13, the pawls 204, 208 are located adjacent to each other in a groove 215 of the housing. The springs 206, 210 bias the pawls 204, 208 towards the center of the piston 203 or towards engagement with the teeth 216 on the outer circumference of the piston 203. A centrally located hole 220 in the pawls 204, 208 and the housing 202 receives an extended pin 212. The position of the pin 212 relative to the pawls 204, 208 and the piston 203 is shown in FIG. 13.

FIGS. 10a and 11 a show a first pawl 204 with teeth 204a in contact with the teeth or grooves 216 on the outer circumference of the piston 203. FIGS. 10b and 11b show the second pawl 208 with teeth 208a, adjacent to the first pawl 204, meshed with the teeth or grooves 216 on the outer circumference of the piston 203. In comparing the positions of the first and second pawls, 204, 208, one pawl, in this case the first tooth 204a of the first pawl 204, is half a pitch ahead of the first tooth 208a of the second pawl 208. In other words, while the teeth of the second pawl 208 are engaged or ratcheted with the teeth 216 of the piston 203, the first pawl 204 is moving or sliding down along the ramp 216a between the tooth engaged by the second pawl 208 and the next tooth 216 along the piston 203. By offsetting the position of the first pawl 204 relative to the second pawl 208 by a half a pitch, finer adjustment of the piston 203 position and the tensioner it provides is achieved, since the first pawl 204 can adjust the back position and then when the piston 203 moves out half a pitch the second pawl 208 takes up the backlash or backward movement that may occur. In one embodiment, the teeth on the piston 203 are preferably larger than in the prior art, giving the teeth on the piston greater strength and wear resistance. In another preferred embodiment, the pawls are thicker than in the prior art, and are therefore able to handle a greater load and are more resistant to wear.

In another preferred embodiment, alternatively, the pawls 204, 208 hold the same position along the grooves or teeth 216 of the outer circumference of the piston 203, ensuring that if one of the pawls 204, 208 failed, the position of the piston 203 remains the same since the other pawl 204, 208 is also engaging the teeth 216 of the piston 203.

Alternatively, distance between the first tooth 204a of the first pawl 204 and the first tooth 208a of the second pawl 208 may be less than a half pitch or greater than a half pitch.

The tensioner of the present invention may be a mechanical tensioner, which uses only spring force to bias the piston outward from the housing, a hydraulic tensioner which uses hydraulic force to bias the piston outward from the housing, or a tensioner that uses a combination of spring force and hydraulic force to bias the piston outward form the housing.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A tensioner comprising:
a housing having a bore;
a piston slidably received within the bore having a plurality of teeth formed along at least a portion of outer circumference of the piston;
a piston spring biasing the piston in an outward direction from the bore;
a first pawl and a second pawl pivotally attached by a pin and received by a groove in the housing, biased toward the teeth formed along the outside of the piston by springs, wherein the first pawl is adjacent to the second pawl in the groove.

2. The tensioner of claim 1, wherein the piston is hollow and forms a fluid chamber with the bore.

3. The tensioner of claim 2, further comprising a check valve in the fluid chamber.

4. The tensioner of claim 1, wherein the first pawl is half a pitch ahead of the second pawl, such that when the second pawl engages a tooth along the outside of the piston, the first pawl slides along a ramp between the tooth the second pawl is engaged with and the next tooth along the outside of the piston.

5. The tensioner of claim 4, wherein the second pawl takes up backlash.

6. The tensioner of claim 4, wherein the first pawl is less than a half a pitch ahead of the second pawl.

7. The tensioner of claim 4, wherein the first pawl is greater than a half a pitch ahead of the second pawl.

8. The tensioner of claim 1, wherein the first pawl and the second pawl hold the same position on the plurality of teeth formed along the outside of the piston.

9. A tensioner comprising:
a housing having a bore;
a piston slidably received within the bore having a plurality of teeth formed along at least a portion of outer circumference of the piston;
a piston spring biasing the piston in an outward direction from the bore;
a first pawl, pivotally attached by a first pin and received in a first groove in the housing, biased toward the teeth formed along the outside of the piston by a first spring, and a second pawl, spaced at least 180 degrees from the first pawl, pivotally attached by a second pin and received by a second groove in the housing, biased toward the teeth formed along the outside of the piston by a second spring.

10. The tensioner of claim 9, wherein the piston is hollow and forms a fluid chamber with the bore.

11. The tensioner of claim 10, further comprising a check valve in the fluid chamber.

12. The tensioner of claim 9, wherein the first pawl is half a pitch ahead of the second pawl, such that when the second pawl engages a tooth along the outside of the piston, the first pawl slides along a ramp between the tooth the second pawl is engaged with and the next tooth along the outside of the piston.

13. The tensioner of claim 12, wherein the second pawl takes up backlash.

14. The tensioner of claim 12, wherein the first pawl is less than a half a pitch ahead of the second pawl.

15. The tensioner of claim 12, wherein the first pawl is greater than a half a pitch ahead of the second pawl.

16. The tensioner of claim 9, wherein the second pawl is spaced less than 180 degrees from the first pawl.

17. The tensioner of claim 9, wherein the first pawl and the second pawl hold the same position on the plurality of teeth formed along the outside of the piston.

18. A tensioner comprising:
a housing having a bore;
a hollow piston slidably received within the bore, the piston forming a fluid chamber with the bore and having a plurality of teeth formed along at least a portion of a circumference of the piston;
a first pawl and a second pawl pivotally attached by a pin and received by a groove in the housing, biased toward the teeth formed along the outside of the piston by springs, wherein the first pawl is adjacent to the second pawl in the groove.

19. The tensioner of claim 18, wherein the first pawl is half a pitch ahead of the second pawl, such that when the second pawl engages a tooth along the outside of the piston, the first pawl slides along a ramp between the tooth the second pawl is engaged with and the next tooth along the outside of the piston.

20. The tensioner of claim 19, wherein the second pawl takes up backlash.

21. The tensioner of claim 19, wherein the first pawl is less than a half a pitch ahead of the second pawl.

22. The tensioner of claim 19, wherein the first pawl is greater than a half a pitch ahead of the second pawl.

23. The tensioner of claim 18, wherein the first pawl and the second pawl hold the same position on the plurality of teeth formed along the outside of the piston.

24. The tensioner of claim 18, further comprising a check valve in the fluid chamber.

25. A tensioner comprising:
a housing having a bore;
a hollow piston slidably received within the bore, the piston forming a fluid chamber with the bore and having a plurality of teeth formed along at least a portion of a circumference of the piston;
a first pawl, pivotally attached by a first pin and received in a first groove in the housing, biased toward the teeth formed along the outside of the piston by a first spring, and a second pawl, spaced at least 180 degrees from the first pawl, pivotally attached by a second pin and received by a second groove in the housing, biased toward the teeth formed along the outside of the piston by a second spring.

26. The tensioner of claim 25, further comprising a check valve in the fluid chamber.

27. The tensioner of claim 25, wherein the first pawl is half a pitch ahead of the second pawl, such that when the second pawl engages a tooth along the outside of the piston, the first pawl slides along a ramp between the tooth the second pawl is engaged with and the next tooth along the outside of the piston.

28. The tensioner of claim 27, wherein the second pawl takes up backlash.

29. The tensioner of claim 27, wherein the first pawl is less than a half a pitch ahead of the second pawl.

30. The tensioner of claim 27, wherein the first pawl is greater than a half a pitch ahead of the second pawl.

31. The tensioner of claim 25, wherein the first pawl and the second pawl hold the same position on the plurality of teeth formed along the outside of the piston.

32. The tensioner of claim 25, wherein the second pawl is spaced less than 180 degrees from the first pawl.
